(19) United States
(12) Patent Application Publication
(10) Pub. No.: US 2024/0387855 A1
(43) Pub. Date: Nov. 21, 2024

(54) POWER STORAGE CELL

(71) Applicant: TOYOTA JIDOSHA KABUSHIKI KAISHA, Toyota-shi, Aichi-ken (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke SUZUKI, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi, Aichi-Ken (JP)

(21) Appl. No.: 18/607,681

(22) Filed: Mar. 18, 2024

(30) Foreign Application Priority Data
May 17, 2023 (JP) 2023-081727

(51) Int. Cl. H01M 10/04; H01M 4/04; H01M 50/531

(52) U.S. Cl. CPC H01M 10/0431; H01M 4/0404; H01M 50/531

(57) ABSTRACT

A power storage cell includes: a wound electrode assembly which includes a positive plate (a first electrode) and a negative plate (a second electrode); and a case accommodating the wound electrode assembly. The positive plate includes: a positive current collector (a current collector); a positive electrode mixture layer (an electrode material) with which a portion of the positive current collector is coated; and a positive electrode tab lead (a tab lead). The positive current collector has an uncoated portion that is not coated with the positive electrode mixture layer. An overlapping portion is formed by folding the uncoated portion of the positive current collector in the radial direction of the wound electrode assembly. The positive electrode tab lead is disposed in the overlapping portion.

### CROSS REFERENCE TO RELATED APPLICATIONS

This nonprovisional application is based on Japanese Patent Application No. 2023-081727 filed on May 17, 2023 with the Japan Patent Office, the entire content of which is hereby incorporated by reference.

### BACKGROUND OF THE DISCLOSURE

### Field of the Disclosure

The present disclosure relates to a power storage cell.

### Description of the Background Art

Japanese Patent No. 4805545 discloses a lithium secondary battery that includes a wound internal electrode assembly which includes a positive plate and a negative plate with a separator in between. The positive plate and the negative plate each include a current collector tab. The current collector tabs are attached to portions of the positive plate and the negative plate which are coated with no electrode active material (electrode mixture layer) and where metallic foils are exposed.

### SUMMARY OF THE DISCLOSURE

The internal electrode assembly disclosed in Japanese Patent No. 4805545 includes various members such as positive plates (negative plates), electrode mixture layers, and current collector tabs. Due to this, the internal electrode assembly may not be wound in a manner that the internal electrode assembly has a uniform thickness in the radial direction of the internal electrode assembly (the wound electrode assembly). In this case, the wound electrode assembly is likely to have steps and is, therefore, locally weighted while being confined in the case, for example.

The present disclosure is made to solve the problem, and an object of the present disclosure is to provide a power storage cell that includes a wound electrode assembly having a uniform thickness in the radial direction of the wound electrode assembly.

A power storage cell according to an aspect of the present disclosure includes: a wound electrode assembly which includes a first electrode and a second electrode; and a case accommodating the wound electrode assembly. The first electrode includes: a current collector; an electrode material with which a portion of the current collector is coated; and a tab lead projecting from the current collector in an axial direction of the wound electrode assembly. The current collector: has an uncoated portion that is not coated with the electrode material. The current collector includes an overlapping portion formed by folding the uncoated portion in a radial direction of the wound electrode assembly. The tab lead is disposed in the overlapping portion.

In the power storage cell according to the aspect of the present disclosure, the tab lead is disposed in the overlapping portion as stated above. This can facilitate the adjustment of the thickness of the first electrode in which the tab lead is disposed, by adjusting the number of times the uncoated portion is folded in the overlapping portion. As a result, the first electrode is facilitated to have a uniform thickness. This facilitates the wound electrode assembly to have a uniform radial thickness. As a result, steps can be inhibited from being formed on the wound electrode assembly, thereby inhibiting the wound electrode assembly in a confined state from being locally weighted.

In the power storage cell according to the aspect, preferably, the current collector has a coated portion that is coated with the electrode material. An absolute value of a difference between a first thickness and a second thickness is less than a thickness, in the radial direction, of the current collector corresponding to the coated portion, where the first thickness is a sum of a thickness of the overlapping portion in the radial direction and a thickness of the tab lead in the radial direction, and the second thickness is a sum of a thickness of the electrode material in the radial direction and the thickness, in the radial direction, of the current collector corresponding to the coated portion. With such a configuration, the first electrode can have a more uniform thickness, as compared to the case where the absolute value is greater than or equal to the thickness, in the radial direction, of the current collector corresponding to the coated portion.

In this case, preferably, the first thickness is equal to the second thickness. With such a configuration, the first electrode can have a further uniform thickness.

In the power storage cell according to the aspect, preferably, the overlapping portion is provided in an end portion of the first electrode in a winding direction of the wound electrode assembly. With such a configuration, the first electrode can be inhibited from being locally weighted at the end portions.

In the power storage cell according to the aspect, preferably, the overlapping portion is provided between one end portion of the first electrode and the other end portion of the first electrode in a winding direction of the wound electrode assembly. With such a configuration, the first electrode can be inhibited from being locally weighted between the one end portion and the other end portion.

In the power storage cell according to the aspect, preferably, the overlapping portion is formed by folding the uncoated portion. With such a configuration, the coated portion can be prevented from being folded. As a result, the electrode material can be prevented from being removed from the coated portion by folding the coated portion.

According to the present disclosure, a wound electrode assembly having a uniform radial thickness can be achieved by disposing the positive electrode tab lead in the overlapping portion.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a cross-sectional view showing a configuration of a power storage cell according to an embodiment.

FIG. 2 is a plan view showing a configuration of a positive plate according to the embodiment.

FIG. 3 is a plan view showing a configuration of a negative plate according to the embodiment.

FIG. 4 is a side view showing a configuration of an overlapping portion according to the embodiment.

FIG. 5 is a plan view showing the overlapping portion with a positive electrode tab lead being attached thereto, according to the embodiment.

FIG. 6 is a cross-sectional view showing a thickness of the positive plate, according to the embodiment.

FIG. 7 is a plan view of an overlapping portion with a positive electrode tab lead attached thereto, according to Variation 1 of the embodiment.

FIG. 8 is a side view showing a configuration of the overlapping portion of FIG. 7.

FIG. 9 is a plan view of an overlapping portion with a positive electrode tab lead attached thereto, according to Variation 2 of the embodiment.

FIG. 10 is a plan view of an overlapping portion with a negative electrode tab lead attached thereto, according to Variation 3 of the embodiment.

FIG. 11 is a cross-sectional view showing a thickness of a positive plate, according to Variation 4 of the embodiment.

### DESCRIPTION OF THE PREFERRED EMBODIMENTS

Hereinafter, an embodiment according to the present disclosure will be described, with reference to the accompanying drawings. Note that like reference signs are used to refer to like or corresponding parts in the drawings, and the description thereof will not be repeated.

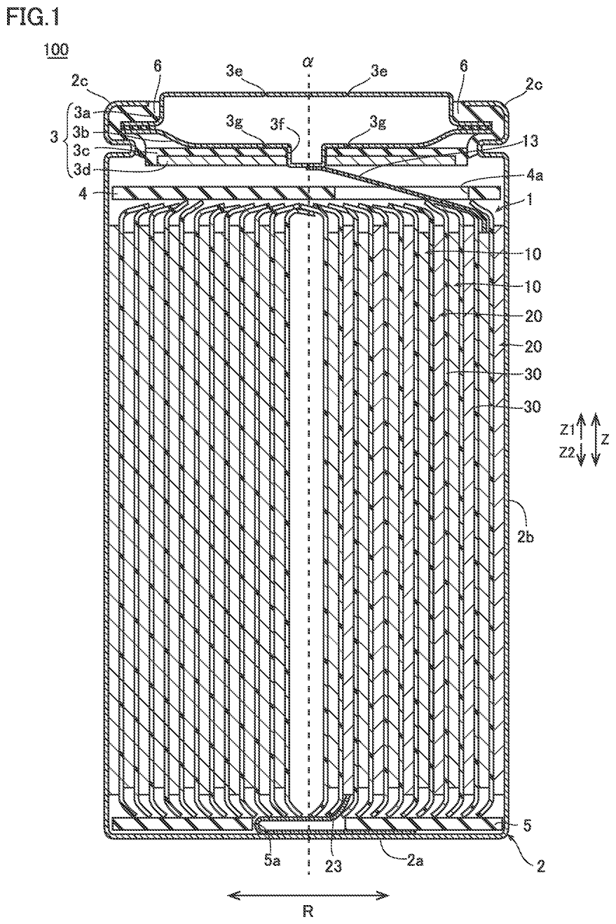

FIG. 1 is a cross-sectional view showing a general configuration of a power storage cell 100 according to an embodiment of the present disclosure. The power storage cell 100 is, for example, a lithium-ion battery that is mounted on a vehicle. Note that the application and type of the power storage cell 100 are not limited thereto.

The power storage cell 100 includes a wound electrode assembly 1, a case 2, a current interrupt device (CID) 3, a positive-side insulating plate 4, a negative-side insulating plate 5, and an insulating layer 6.

The wound electrode assembly 1 is accommodated in the case 2. The case 2 has a cylindrical shape. In other words, the power storage cell 100 is a cylindrical battery.

The wound electrode assembly 1 includes positive plates 10, negative plates 20, and separators 30. The separator 30 is disposed between the positive plate 10 and the negative plate 20. The separator 30 separates the positive plate 10 and the negative plate 20, while allowing ions (e.g., lithium-ions) to traverse between the positive plate 10 (a positive active material) and the negative plate 20 (a negative active material). The wound electrode assembly 1 is configured of a group of electrode plates in which the positive plate 10 and the negative plate 20 are wound via the separator 30. Note that the positive plate 10 and the negative plate 20 are one example of a “first electrode” and a “second electrode,” respectively, according to the present disclosure.

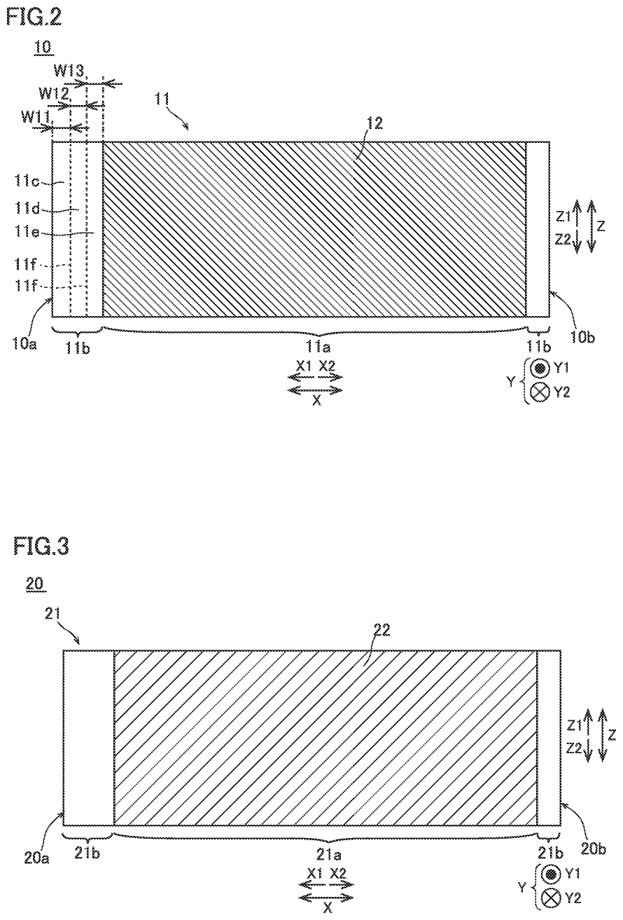

FIG. 2 shows the unwound positive plate 10 as viewed from the Y1 side. The positive plate 10 has a rectangular shape having the long sides extending in X direction and the short sides extending in Z direction. Note that X direction is one example of a “winding direction” according to the present disclosure. Z direction is one example of an “axial direction” according to the present disclosure. Note that Y direction corresponds to R direction of FIG. 1. R direction is one example of a “radial direction” according to the present disclosure.

As shown in FIG. 2, the positive plate 10 includes a positive current collector 11 and a positive electrode mixture layer 12 (the hatched portion). A portion of the positive current collector 11 is coated with the positive electrode mixture layer 12. In other words, the positive current collector 11 includes a coated portion 11a that is coated with the positive electrode mixture layer 12, and uncoated portions 11b that are not coated with the positive electrode mixture layer 12.

In the example shown in FIG. 2, the uncoated portion 11b is provided at an end portion 10a of the positive plate 10 on X1 side and an end portion 10b of the positive plate 10 on X2 side. The coated portion 11a is provided between the uncoated portion 11b on X1 side and the uncoated portion 11b on X2 side. In the present embodiment, X1 side and X2 side will be referred to as a winding end side and a winding start side, respectively, for the wound electrode assembly 1. Note that the positive current collector 11 and the positive electrode mixture layer 12 are one example of a “current collector” and an “electrode material,” respectively, according to the present disclosure.

For example, aluminum is used for the positive current collector 11. The positive electrode mixture layer 12 is formed by coating a surface of the positive current collector 11 with a cathode slurry and drying. The cathode slurry is prepared by mixing the materials (such as a positive active material and a binder) of the positive electrode mixture layer 12 and a solvent. The positive electrode mixture layer 12 is appressed to the separator 30 (see FIG. 1). The positive electrode mixture layer 12 has a thickness greater than or equal to 0.1 μm and less than or equal to 1000 μm, for example.

FIG. 3 shows the unwound negative plate 20 as viewed from Y1 side. Similarly to the positive plate 10, the negative plate 20 has a rectangular shape having the long sides extending in X direction and the short sides extending in Z direction.

As shown in FIG. 3, the negative plate 20 includes a negative current collector 21 and a negative electrode mixture layer 22 (the hatched portion). A portion of the negative current collector 21 is coated with the negative electrode mixture layer 22. In other words, the negative current collector 21 includes a coated portion 21a that is coated with the negative electrode mixture layer 22, and uncoated portions 21b that are not coated with the negative electrode mixture layer 22.

The uncoated portion 21b is provided at an end portion 20a of the negative plate 20 on X1 side and an end portion 20b of the negative plate 20 on X2 side. The coated portion 21a is provided between the uncoated portion 21b on X1 side and the uncoated portion 21b on X2 side. The coated portion 21a of the negative plate 20 is provided facing (overlapping, in Y direction, with) the coated portion 11a of the positive plate 10. The uncoated portion 21b of the negative plate 20 is provided facing (overlapping, in Y direction, with) the uncoated portion 11b of the positive plate 10. This allows, as the positive plate 10 and the negative plate 20 are wound, the coated portion 11a and the uncoated portion 11b to be arranged at positions corresponding to the positions of the coated portion 21a and the uncoated portion 21b, respectively, in the circumferential direction of the power storage cell 100.

For example, copper foil is used for the negative current collector 21. The negative electrode mixture layer 22 is formed by coating a surface of the negative current collector 21 with an anode slurry and drying. The anode slurry is prepared by mixing the materials (such as a negative active material and a binder) of the negative electrode mixture layer 22 and a solvent. The negative electrode mixture layer 22 is appressed to the separator 30 (see FIG. 1). The negative electrode mixture layer 22 has a thickness greater than or equal to 0.1 μm and less than or equal to 1000 μm, for example.

Referring, again, to FIG. 1, the positive plate 10 includes a positive electrode tab lead 13. The positive electrode tab lead 13 projects from the positive current collector 11 (see FIG. 2) toward Z1 side. Note that the positive electrode tab lead 13 is one example of a “tab lead” according to the present disclosure.

The negative plate 20 includes a negative electrode tab lead 23. The negative electrode tab lead 23 projects from the negative current collector 21 (see FIG. 2) toward Z2 side.

The positive-side insulating plate 4 is accommodated in the case 2. The positive-side insulating plate 4 insulates the wound electrode assembly 1 (the negative plate 20 and the separator 30) from the case 2. The positive-side insulating plate 4 covers the positive current collector 11, the negative plate 20, and the separator 30 from Z1 side.

The positive-side insulating plate 4 has a through hole 4a. The positive electrode tab lead 13 passes through the through hole 4a and is in contact with a conductive film 3b described below. This electrically connects the positive electrode tab lead 13 and the conductive film 3b.

The negative-side insulating plate 5 is accommodated in the case 2. The negative-side insulating plate 5 insulates the wound electrode assembly 1 (the positive plate 10 and the separator 30) from the case 2. The negative-side insulating plate 5 covers the positive plate 10, the negative current collector 21, and the separator 30 from Z2 side.

The negative-side insulating plate 5 has a through hole 5a. The negative electrode tab lead 23 passes through the through hole 5a and is in contact with a bottom 2a of the case 2. This electrically connects the negative electrode tab lead 23 and the bottom 2a of the case. As a result, the side surface 2b of the case 2 in contact with the bottom 2a of the case 2 is negatively charged. Note that the side surface 2b is in contact with the negative current collector 21 of the negative plate 20 on the outermost periphery of the wound electrode assembly 1.

The CID 3 is an element that interrupts the current path, using an increase of the internal cell pressure caused by a gas generated due to overcharging of the power storage cell 100. The CID 3 seals the opening in the case 2 on Z1 side. The CID 3 has an external cap 3a, a conductive film 3b, a gasket 3c, and a bottom disk 3d.

The external cap 3a has a function as an external terminal by being electrically connected to an external busbar (not shown). The external cap 3a has a weakened portion 3e (a thin portion). As the internal pressure of the case 2 increases, the external cap 3a breaks, starting from the weakened portion 3e. This promptly exhausts the gas out of the case 2.

The conductive film 3b seals the opening in the case 2 on Z1 side. The conductive film 3b includes a projection 3f projecting toward the wound electrode assembly 1 side (Z2 side). The projection 3f is in contact with the positive electrode tab lead 13. This causes the conductive film 3b to be positively charged. The conductive film 3b is also electrically connected to the external cap 3a. This causes the external cap 3a to be positively charged as well. Note that the projection 3f passes through the gasket 3c and the bottom disk 3d.

Similarly to the external cap 3a, the conductive film 3b includes a weakened portion 3g (a thin portion). As the internal pressure of the case 2 increases, the conductive film 3b breaks, starting from the weakened portion 3g. If the internal pressure increases and the conductive film 3b breaks, the conductive film 3b and the positive electrode tab lead 13 are no longer in contact. As a result, the conductive film 3b is no longer positively charged, and the external cap 3a is no longer positively charged either. As a result, charging of and discharging from the power storage cell 100 are stopped.

The case 2 includes a crimp 2c that is crimped to the outer periphery of the external cap 3a. The insulating layer 6 insulates the crimp 2c from the external cap 3a (and the conductive film 3b).

Referring, again, to FIG. 2, the uncoated portion 11b on X1 side includes a first portion 11c, a second portion 11d, and a third portion 11e that are adjacent to each other in X direction. Specifically, the first portion 11c, the second portion 11d, and the third portion 11e are disposed in the listed order starting from X1 side. Note that a width W11 of the first portion 11c in X direction, a width W12 of the second portion 11d in X direction, and a width W13 of the third portion 11e in X direction are equal.

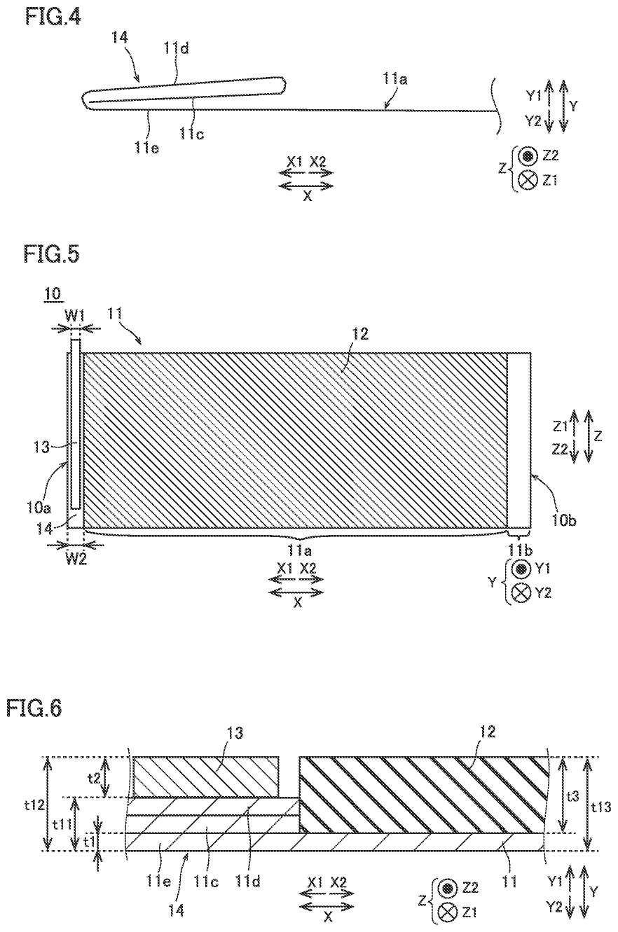

As shown in FIG. 4, an overlapping portion 14 is formed by bending (folding) the uncoated portion 11b (the first portion 11c, the second portion 11d, and the third portion 11e) of the positive current collector 11. In FIG. 4, the uncoated portion 11b, which is the overlapping portion 14, is folded in Y direction. The overlapping portion 14 is formed in which the first portion 11c is sandwiched between the second portion 11d and the third portion 11e.

The overlapping portion 14 is formed by folding the uncoated portion 11b. In other words, folds 11f (see the dashed lines of FIG. 2) are formed within the uncoated portion 11b. The folds 11f extend along Z direction.

Here, the wound electrode assembly 1 includes various members such as the positive plates 10 (the negative plates 20), the electrode mixture layers (12, 22), and the tab leads (13, 23). Due to this, with a conventional configuration, a wound electrode assembly having a uniform radial thickness may not be achieved. In this case, the wound electrode assembly is likely to have steps, and is, therefore, locally weighted while being confined in the case, for example.

Thus, the power storage cell 100 according to the present embodiment includes the positive electrode tab lead 13 within the overlapping portion 14, as shown in FIG. 5. This can facilitate the overlapping portion 14 to have an increased thickness (the total thickness of the overlapping portion 14 plus the positive electrode tab lead 13). As a result, steps (steps in the radial direction) can be prevented from being formed on the wound electrode assembly 1, which is caused by the difference in thickness between the uncoated portion 11b and the coated portion 11a. Note that the positive electrode tab lead 13 is welded to the overlapping portion 14 of the positive current collector 11, for example.

The positive electrode tab lead 13 is accommodated within the overlapping portion 14 in X direction. Stated differently, the width W1 of the positive electrode tab lead 13 in X direction is less than the width W2 of the overlapping portion 14 in X direction. The positive electrode tab lead 13 is disposed in the middle of the overlapping portion 14 in X direction. Note that the width W1 and the width W2 may be equal.

In the present embodiment, the overlapping portion 14 includes the end portion 10a of the positive plate 10 on X1 side in X direction. In other words, the overlapping portion 14 is provided on the winding end side of the wound electrode assembly 1 in a wound state.

As shown in FIG. 6, the positive current collector 11 has a thickness t1 in Y direction. Note that the thickness t1 is the thickness of the positive current collector 11. Accordingly, the thickness t11 of the overlapping portion 14 in Y direction is three times (t11=3×t1) the thickness t1. Note that the thickness t1 is one example of a “thickness in the radial direction of the current collector corresponding to the coated portion,” according to the present disclosure.

The positive electrode tab lead 13 has a thickness t2 in Y direction. Accordingly, the thickness t12 of the positive plate 10 corresponding to the overlapping portion 14 is the sum of the thickness t11 of the overlapping portion 14 and the thickness t2 of the positive electrode tab lead 13 (t12=t11+t2). Note that, in the example shown in FIG. 2, the thickness t2 of the positive electrode tab lead 13 is greater than the thickness t1 of the positive current collector 11. The thickness t2 may be less than or equal to the thickness t1. Note that the thickness t12 is one example of a “first thickness” according to the present disclosure.

The positive electrode mixture layer 12 has a thickness t3 in Y direction. Accordingly, the thickness t13 of the positive plate 10 corresponding to the coated portion 11a is the sum of the thickness t3 of the positive electrode mixture layer 12 and the thickness t1 of the positive current collector 11 (t13=t3+t1). Note that the thickness t3 of the positive electrode mixture layer 12 is greater than the thickness t2 of the positive electrode tab lead 13. The thickness t13 is one example of a “second thickness” according to the present disclosure.

In the present embodiment, the thickness t12 is equal to the thickness t13. Stated differently, the positive plate 10 is formed so that a portion of the positive plate 10 corresponding to the overlapping portion 14 and a portion of the positive plate 10 corresponding to the coated portion 11a have a uniform thickness.

As described above, in the present embodiment, the positive electrode tab lead 13 is disposed at the overlapping portion 14 of the positive current collector 11. This can facilitate the portion of the positive plate 10, where the positive electrode tab lead 13 is disposed, has an increased thickness (t12), without having to change the thickness (t2) of the positive electrode tab lead 13, for example. As a result, the wound electrode assembly 1 can be facilitated to have a uniform radial thickness.

In the above embodiment, the positive plate 10 includes the overlapping portion 14 in the end portion 10a of the positive plate 10 on X1 side. However, the present disclosure is not limited thereto. The location of the overlapping portion 14 is not limited to the embodiment.

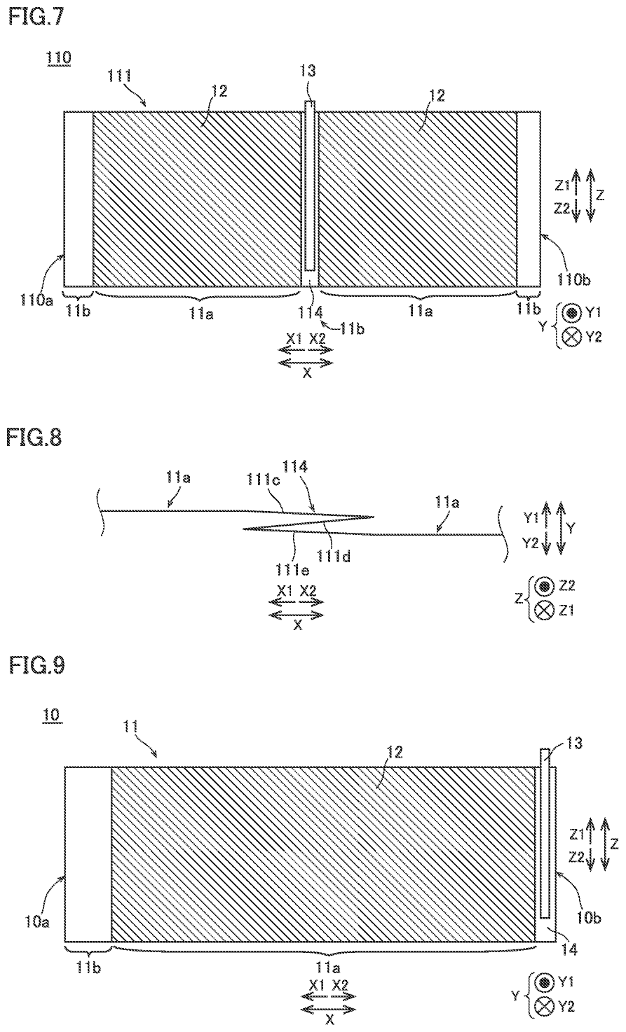

FIG. 7 shows a positive plate 110 according to a variation of the embodiment. The positive plate 110 includes a positive current collector 111. In the example shown in FIG. 7, the uncoated portion 11b is provided between an end portion 110a and an end portion 110b, in addition to being disposed in an end portion 110a of the positive plate 110 on X1 side and an end portion 110b of the positive plate 110 on X2 side. Note that the positive plate 110 and the positive current collector 111 are one example of a “first electrode” and a “current collector,” respectively, according to the present disclosure.

As shown in FIG. 7, the overlapping portions 114 is formed of the uncoated portion 11b between the end portion 110a and the end portion 110b. The positive electrode tab lead 13 is attached to the overlapping portion 114.

FIG. 8 is a diagram showing the positive plate 110 of FIG. 7 as viewed from Z2 side. The overlapping portion 114 is formed of the first portion 111c, the second portion 111d, and the third portion 111e being overlapped. The first portion 111c, the second portion 111d, and the third portion 111e are disposed in the listed order starting from X1 side. The overlapping portion 114 is disposed so that the second portion 111d is sandwiched between the first portion 111c and the third portion 111e in Y direction. In other words, the overlapping portion 114 is formed by meandering the uncoated portion 11b.

In the above embodiment, the positive plate 10 includes the overlapping portion 14 at the end portion 10a of the positive plate 10 on X1 side. However, the present disclosure is not limited thereto. The positive plate 10 may include the overlapping portion 14 at the end portion 10b of the positive plate 10 on X2 side, as shown in FIG. 9. The positive plate 10 may also include the overlapping portion 14 at the end portion 10a on X1 side and the end portion 10b on X2 side.

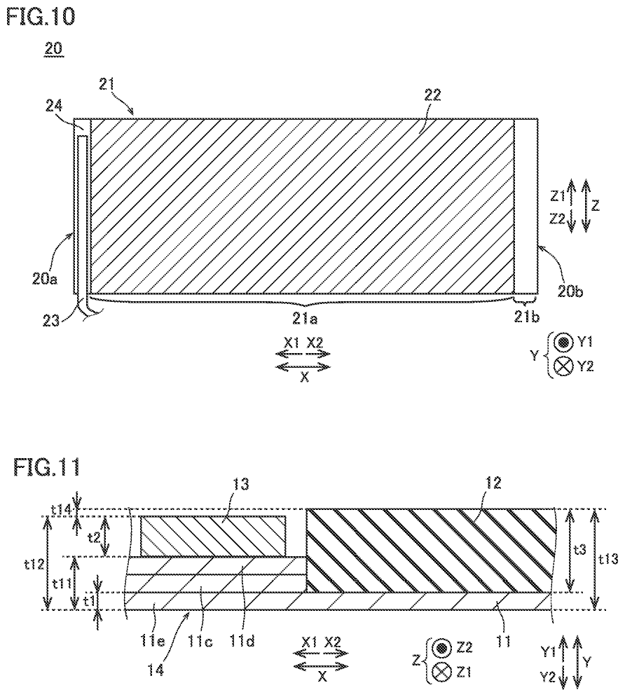

In the above embodiment, the positive plate 10 includes the overlapping portion 14. However, the present disclosure is not limited thereto. As shown in FIG. 10, the negative plate 20 may include an overlapping portion 24 that is formed by folding the uncoated portion 21b of the negative current collector 21. In this case, the negative electrode tab lead 23 is attached to the overlapping portion 24. Note that the positive plate 10 and the negative plate 20 may each include the overlapping portion 14 (24). In the example shown in FIG. 10, the negative plate 20 includes the overlapping portion 24 at the end portion 20a of the negative plate 20 on X1 side. However, the negative plate 20 may include the overlapping portion 24 at the end portion 20b of the negative plate 20 on X2 side and between the end portion 20a and the end portion 20b.

In the above embodiment, the thickness t12 of the positive plate 10 corresponding to the overlapping portion 14 and the thickness t13 of the positive plate 10 corresponding to the coated portion 11a are equal. However, the present disclosure is not limited thereto. The thickness t12 and the thickness t13 may differ, as shown in FIG. 11. In the example shown in FIG. 11, a difference t14 between the thickness t12 and the thickness t13 is less than the thickness t1 of the positive current collector 11 (|t12−t13|<t1). Note that, while FIG. 11 shows the thickness t12 as being less than the thickness t13, the thickness t12 may be greater than the thickness t13.

In the above embodiment, the folds 11f are formed in the uncoated portion 11b. However, the present disclosure is not limited thereto. For example, the uncoated portions 11b may be folded by folding the positive current collector 11 along the folds formed in the coated portion 11a between the uncoated portions 11b.

Although the embodiment according to the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage cell, comprising:
a wound electrode assembly which includes a first electrode and a second electrode; and
a case accommodating the wound electrode assembly, wherein
the first electrode includes:
a current collector;
an electrode material with which a portion of the current collector is coated; and
a tab lead projecting from the current collector in an axial direction of the wound electrode assembly, wherein
the current collector:
has an uncoated portion that is not coated with the electrode material; and
includes an overlapping portion formed by folding the uncoated portion in a radial direction of the wound electrode assembly, wherein
the tab lead is disposed in the overlapping portion.

2. The power storage cell according to claim 1, wherein
the current collector has a coated portion that is coated with the electrode material, and
an absolute value of a difference between a first thickness and a second thickness is less than a thickness, in the radial direction, of the current collector corresponding to the coated portion, where
the first thickness is a sum of a thickness of the overlapping portion in the radial direction and a thickness of the tab lead in the radial direction, and
the second thickness is a sum of a thickness of the electrode material in the radial direction and the thickness, in the radial direction, of the current collector corresponding to the coated portion.

3. The power storage cell according to claim 2, wherein
the first thickness is equal to the second thickness.

4. The power storage cell according to claim 1, wherein
the overlapping portion is provided in an end portion of the first electrode in a winding direction of the wound electrode assembly.

5. The power storage cell according to claim 1, wherein
the overlapping portion is provided between one end portion of the first electrode and the other end portion of the first electrode in a winding direction of the wound electrode assembly.

6. The power storage cell according to claim 1, wherein
the overlapping portion is formed by folding the uncoated portion.
